(19) United States
(12) Patent Application Publication
(10) Pub. No.: US 2007/0182706 A1
(43) Pub. Date: Aug. 9, 2007

(54) REFLECTIVE DISPLAY DEVICES

(75) Inventors: Micheal Cassidy, Rathmines, Dublin 6 (IE); Nigel Leyland, Ballsbridge, Dublin 4 (IE); David Corr, Goatstown, Dublin 14 (IE)

Correspondence Address: VOLPE AND KOENIG, P.C., UNITED PLAZA, SUITE 1600, 30 SOUTH 17TH STREET, PHILADELPHIA, PA, 19103, US

(73) Assignee: NTERA Limited, Dublin (IE)

(21) Appl. No.: 11/622,862

(22) Filed: Jan. 12, 2007

Related U.S. Application Data
(60) Provisional application No. 60/759,248, filed on Jan. 13, 2006.
(60) Provisional application No. 60/759,256, filed on Jan. 13, 2006.
(60) Provisional application No. 60/759,249, filed on Jan. 13, 2006.

(51) Int. Cl. G09G 3/34

(52) U.S. Cl. 345/107

(57) ABSTRACT

An enhanced reflective layer is described herein for use in a display device. Displays including the enhanced reflective layer are also described. The enhanced reflective layer includes particles that reflect, absorb or emit light with desired properties to enhance the display properties. Use of the enhanced reflective layer in displays allows, among other features, full color active matrix reflective or transflective displays.

### CROSS REFERENCE TO RELATED APPLICATIONS

This application claims the benefit of U.S. Provisional Application Nos. 60/759,248; 60/759,256; and 60/759,249, each of which were filed Jan. 13, 2006, and are incorporated by reference herein in their entirety as if fully set forth.

### FIELD OF INVENTION

The invention relates to reflective displays and reflectors with enhanced functionality within reflective displays.

### BACKGROUND

Many transmissive or emissive displays such as backlit liquid crystal displays (LCD), organic light-emitting diode displays (OLED), and electroluminescent displays (EL) are not readily visible due to their low contrast in high ambient light conditions. In contrast, reflective display technologies have received considerable attention for their visibility under a wide range of ambient lighting conditions including outdoors daylight. Additionally, reflective displays have the capability to reduce the power consumption of the display since the light energy is derived from the ambient surroundings and simply modulated by the electro-optic response of the display.

FIG. 1 illustrates a reflective ion-permeable nano-structured film 140 in a prior art electrochromic display device 100. In device 100, a nano-structured metal oxide film 130 is deposited onto a glass substrate 105 coated with a transparent conductor 120. Segmented areas are defined on an opposing substrate 180 which consists of areas of a patterned transparent conductor 170 and another nano-structured metal-oxide film 160 with adsorbed chromophore 165. An electrolyte 150 is provided between the two substrates 105, 180. The display is viewed from the top as it appears in FIG. 1. The chromophore 165 changes color according to its redox state that is controlled by an applied voltage or current. By controlling the redox state of the chromophore, light can be effectively transmitted or filtered in proportion and in relation to the coloration of the chromophore. The light is then reflected off the reflective ion-permeable nano-structured film 140 back toward the viewer. The patterned areas of transparent conductor 170 define electrodes for control of the segments. By controlling each segment, the adsorbed chromophore 165 in each segment may be caused to absorb or transmit light independent of the other segments. In order to maintain reflectivity, the reflective ion-permeable nano-structured film 140 must be electrochemically inert within the operating range of the device and with respect to the nature of the electrolyte.

FIG. 2 illustrates a patterned metallic reflective layer 267 in a prior art active-matrix addressed reflective liquid crystal (LC) display 200. Layers 290-293 define a TFT structure widely known to those skilled in the art. Often the patterned metallic reflective layer 267 is sputtered onto the underlying layer 251, which may be a polymer. In order to create a non-specularly reflective surface, underlying layer 251 may be patterned to create a non-planar surface. An additional layer of ITO may be deposited on top of the metal layer in order to match the work function of the materials on either side of the LC cell. In this example, 2 or 3 patterned layers are required to present a diffuse reflector layer. Additionally, the cell gap varies across the surface area of the pixel which impacts the optical performance of the display.

FIG. 3 illustrates a prior art active-matrix addressed lateral electrophoretic display 300. In this case, charged electrophoretic particles 352 in a liquid or gas medium 371 are caused to move under the action of an applied field between electrodes 334, 344. Under the applied field, the charged electrophoretic particles 352 either predominantly show the underlying surface 326, or occlude this surface 326 and present the optical properties of the charged electrophoretic particles 352. The particles are confined within cell walls 361 defining a pixel area and the underlying surface 326 is an opaque material which exhibits a predominantly white state. Alternatively, it is possible to provide a desired optical state such as whiteness or reflectivity to electrode 344. In this case, however, it may be difficult to provide a non-specularly reflective surface or to provide any enhancement to the reflector layer.

Generally, the operation of reflective displays may be achieved through a combination of a reflector and a light modulator (e.g., an electro-optic material). In the examples above, chromophore 165 adsorbed to nanostructured film 160 (electrochromic displays), liquid crystal (LC displays), and charged electrophoretic particles 352 (electrophoretic displays) act as the electro-optic material. By controlling the electro-optic material, the amount of light incident on an individually addressable section of a reflective display may be modulated in such a way that a certain proportion of the incident light on that section is controllably reflected toward the viewer. Alternatively, reflectivity may be imparted in whole or part as a function of the electro-optic material, however, the principle is similar; at least a portion of incident light is controllably re-directed toward the viewer. In either case, the light intensity and/or spectral density of re-directed light is controlled. The controllable region (commonly defined as a segment or pixel) can, thus, convey visual information according to the modulation imparted by the electro-optic material. An array of controllable pixels may be used to depict high-resolution images.

The maximum brightness of reflective display pixels when in a non-absorbing state (e.g., a light pixel) is a function of reflectivity and aperture ratio and is defined as follows: [(reflectivity of the material X the aperture ratio)—system losses]. Reflectivity in these displays is imparted by a reflective material, which is often a metal film or an opaque layer, and the aperture ratio is generally defined as the controllable pixel area to total pixel area ratio. A less than perfect aperture ratio leads to duller displays and lower contrast. System losses include non-ideal transmission response by the electro-optic material, front-screen polarizer, transparent conductors, glass, etc. Based on these relationships, maximizing the brightness of a reflective display is dependent on optimizing the reflectivity and aperture ratio of a reflective display while decreasing the contribution of non-ideal transmission responses.

Despite the relationship between reflectivity, aperture ratio, system losses, and their effect on brightness, many high resolution displays suffer from low contrast in normal lighting conditions. This low contrast problem occurs because the total available reflective area is less than the total area of a segment/pixel. In turn, the reduction in reflective area occurs because there needs to be spacing between each pixel area in order to avoid electrical conductivity and define cell structures. In addition, non-ideal material properties of the reflective layer or transmissive layers in many displays contribute to a less bright image when compared with fixed print media. As a result, many reflective technologies to date, such as reflective LCD, electrophoretic, etc. have demonstrated poor readability in low ambient light levels since the absolute luminance value is quite low.

It is normal in many of these displays to provide color through the use of color filters. Often, the addition of the color filter layers incurs additional costs of production on top of the reflector layer. Additionally, a color filter layer requires another amount of alignment tolerance which may necessitate increasing the size of a black-mask so that color distortions do not occur. The additional black-mask then contributes to a reduction in reflective area, reduction in the aperture, reduction in brightness and reduction in contrast.

Given the above, there remains a need for reflective displays including enhanced reflective properties, and enhanced reflective elements within said displays.

### SUMMARY

In one aspect, the invention herein provides a display comprising an electro-optic material operatively connected to a control element, and a reflective layer located beneath the electro-optic material. The reflective layer includes first medium and particles. The electro-optic material is switchable from a first state in which incident light may strike the enhanced reflective layer and a second state in which incident light is at least partially blocked from the reflective layer. The state of the electro-optic material is controlled through the control element.

In a second aspect, the invention herein includes a method of providing enhanced reflectivity in a display device. The display comprises an electro-optic material operatively connected to a control element, and a reflective layer located on a substrate and beneath the electro-optic material. The reflective layer includes first medium and particles. The electro-optic material is switchable from a first state in which incident light may strike the enhanced reflective layer and a second state in which incident light is at least partially blocked from the reflective layer. The state of the electro-optic material is controlled through the control element. The method of providing enhanced reflectivity comprises applying the reflective layer including particles to the substrate. The particles are selected from the group consisting of suspended particles, segment particles and peripheral particles.

In a third aspect, the invention provides a method of enhancing the brightness in a display comprising providing an enhanced reflective layer. The enhanced reflective layer includes at least one type of reflective particles selected from the group consisting of suspended particles, segment particles and peripheral particles.

### BRIEF DESCRIPTION OF THE DRAWINGS

The following detailed description of the preferred embodiment of the present invention will be better understood when read in conjunction with the appended drawings. For the purpose of illustrating the invention, there are shown in the drawings embodiments which are presently preferred. It is understood, however, that the invention is not limited to the precise arrangements and instrumentalities shown. In the drawings:

FIG. 1 illustrates a section of a prior art electrochromic display device.

FIG. 2 illustrates a section of a prior art active-matrix addressed reflective LCD display.

FIG. 3 illustrates a prior art active-matrix addressed lateral electrophoretic display.

FIG. 4a illustrates an enhanced reflective layer in an electrochromic display. Electro-optic material and a patterned transparent conductive layer are proximal to the enhanced reflective layer.

FIG. 4b illustrates an enhanced reflective layer in an electrochromic display. Electro-optic material and a patterned transparent conductive layer are distal to the enhanced reflective layer.

FIG. 4c illustrates an enhanced reflective layer and an additional transparent layer in an electrochromic display. Electro-optic material and a patterned transparent conductive layer are proximal to the additional transparent layer.

FIG. 4d illustrates an enhanced reflective layer and an additional transparent layer in an electrochromic display. Electro-optic material and a patterned transparent conductive layer are distal to the additional transparent layer and enhanced reflective layer.

FIG. 4e illustrates an enhanced reflective layer that includes segmented areas in an electrochromic display. Electro-optic material and a patterned transparent conductive layer are proximal to the enhanced reflective layer.

FIG. 4f illustrates an enhanced reflective layer that includes segmented areas in an electrochromic display. Electro-optic material and a patterned transparent conductive layer are distal to the additional transparent layer and enhanced reflective layer.

FIG. 4g illustrates an enhanced reflective layer that includes segmented areas and an additional transparent layer on top of the enhanced reflective layer in an electrochromic display. Electro-optic material and a patterned transparent conductive layer are proximal to the additional transparent layer.

FIG. 4h illustrates an enhanced reflective layer that includes segmented areas and an additional transparent layer on top of the enhanced reflective layer in an electrochromic display. Electro-optic material and a patterned transparent conductive layer are distal to the additional transparent layer and enhanced reflective layer.

FIG. 4i illustrates enhanced reflective layer that includes segmented areas and peripheral particles in an electrochromic display. Electro-optic material and a patterned transparent conductive layer are proximal to the enhanced reflective layer.

FIG. 4j illustrates an enhanced reflective layer that includes segmented areas and peripheral particles in an electrochromic display. Electro-optic material and a patterned transparent conductive layer are distal to the enhanced reflective layer.

FIG. 4k illustrates an enhanced reflective layer that includes segmented areas and peripheral particles, and an additional transparent layer on top of the enhanced reflective layer in an electrochromic display. Electro-optic material and a patterned transparent conductive layer are proximal to the additional transparent layer.

FIG. 4l illustrates an enhanced reflective layer that includes segmented areas and peripheral particles, and an additional transparent layer on top of the enhanced reflective layer in an electrochromic display. Electro-optic material and a patterned transparent conductive layer are distal to the additional transparent layer.

FIG. 4m illustrates absorbing peripheral particles.

FIG. 5a illustrates an active matrix addressed electrochromic device which includes a two tier enhanced reflective layer.

FIG. 5b illustrates an active matrix addressed electrochromic device which includes a single tier enhanced reflective layer.

FIG. 5c illustrates an active matrix addressed electrochromic device which includes a two tier enhanced reflective layer and an additional transparent layer.

FIG. 5d illustrates an active matrix addressed electrochromic device which includes a single tier enhanced reflective layer and an additional transparent layer.

FIG. 6a illustrates an active matrix addressed electrochromic device which includes a two tier segmented enhanced reflective layer, an additional transparent layer, and different types of particles in each segment.

FIG. 6b illustrates an active matrix addressed electrochromic device which includes a two tier segmented enhanced reflective layer, an additional transparent layer, different types of particles in each segment, and peripheral particles.

FIG. 7a illustrates an enhanced reflective layer incorporated in a reflective LC display.

FIG. 7b illustrates an enhanced reflective layer and additional transparent layers incorporated in a reflective LC display.

FIG. 8a illustrates an enhanced reflective layer in an active-matrix addressed lateral electrophoretic device.

FIG. 8b illustrates an enhanced reflective layer and additional transparent layers in an active-matrix addressed lateral electrophoretic device.

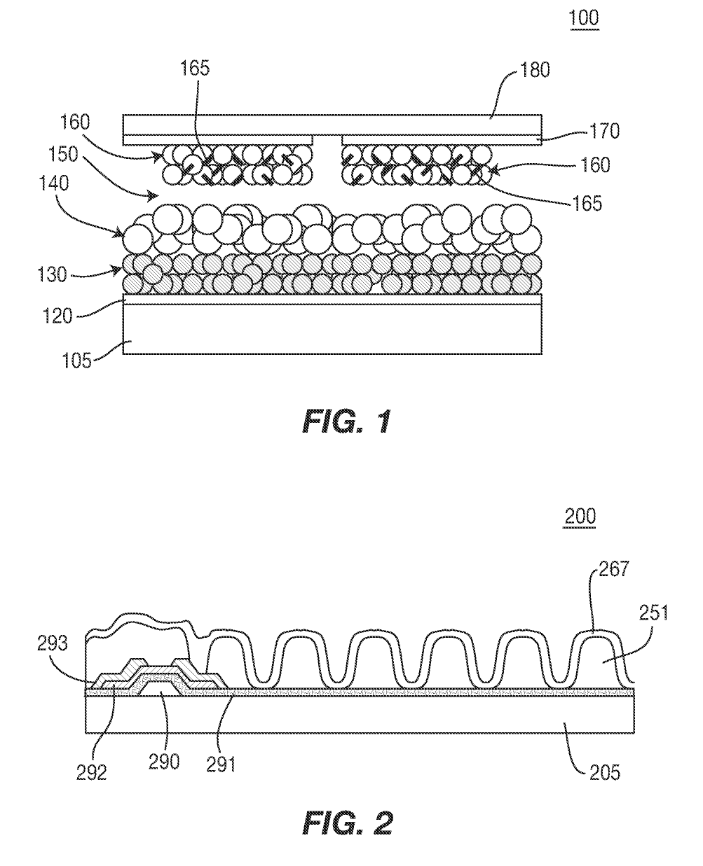

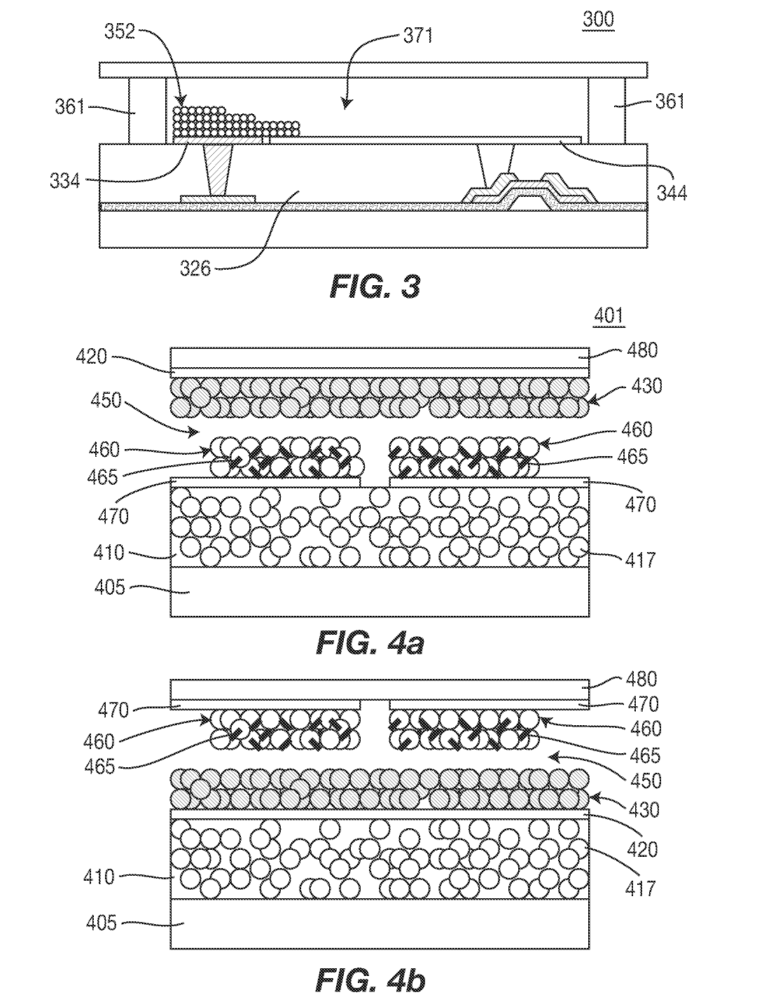

### DETAILED DESCRIPTION OF THE PREFERRED EMBODIMENTS

Certain terminology is used in the following description for convenience only and is not limiting. The words “right,” “left,” “top,” and “bottom” designate directions in the drawings to which reference is made.

As used herein, the phrase “operatively connected” means that two or more elements are connected to each other by function whether they are connected physically, directly, indirectly, chemically, or the like. For example, an electro-optic material is operatively connected to a control element even if it is not directly and physically attached to the control element if application of electrical charge, voltage, current or the like causes modulation of the electro-optic material.

As used herein, the phrase “control element” means any electrical element used to control a display device whether the display is a direct drive, passive, or active matrix display. Under this definition, control element includes, but is not limited to an electrode or a thin film transistor (TFT).

As used herein, the phrase “charged electrophoretic particle(s)” is distinguished from particle, reflective particle, suspended particle, or peripheral particle. “Charged electrophoretic particle(s)” refers to the electro-optic material of electrophoretic displays. “Particle,” “reflective particle,” “suspended particle,” or “peripheral particle,” as used herein are elements within an enhanced reflective or additional layer and can provide reflective, absorptive, or emissive properties within the enhanced reflective layer or additional layer, as described below.

The words “a,” “and,” “one,” as used in the claims and in the corresponding portions of the specification, are defined as including one or more of the referenced item unless specifically stated otherwise. This terminology includes the words above specifically mentioned, derivatives thereof, and words of similar import.

Apparatuses and methods are described herein that provide a reflector functionality incorporated into a layer of a reflective display. The layer may be easily and cheaply applied to the display by such means as coating or printing. In general, the embodiments herein include particles of a desired optical nature suspended within a medium. In some embodiments, the medium is translucent, in more preferred embodiments the medium is substantially transparent, and in still more preferred embodiments the medium is transparent. The medium containing particles may be applied to a reflective display to provide an enhanced reflective layer. By the dispersion of suspended particles in the enhanced reflective layer, an uneven surface may be provided to break up specular reflections. In preferred embodiments, the enhanced reflective layer is provided beneath a non-emissive electro-optic material in a reflective display.

In some embodiments, the enhanced reflector layer may be applied by printing, spin coating or laminating a layer of the medium with suspended particles. In preferred embodiments, the deposition methods are spin-coating, screen-printing, blade-coating, ink-jet printing, roll coating, spraying or laminating onto a material. In preferred embodiments, the material to which the layer is applied is a bottom substrate of a reflective display. The media may be translucent, while the preferred media are transparent plastics or glasses. The particles may be comprised of any light scattering or reflective materials, and/or any emissive substance (e.g., fluorescent or phosphorescent substance including elements, compounds, polymers, monomers, dimers, multimers, or the like). Light scattering or reflective particles may include pigments. Preferred light scattering or reflective materials are listed in Table 1, and preferred emissive substances are listed in Tables 2 and 3.

TABLE 1

| Material | Color |
|---|---|
| Titanium dioxide | White |
| Zinc oxide | White |
| Zirconium oxide | White |
| Cadmium sulfide | Yellow |
| Cadmium selenide | Red |
| Sodium aluminosilicate | Blue |
| Chromium (III) oxide | Green |
| Carbon black | Black |

In addition to the materials of TABLE I, other suitable light scattering or reflective materials may be used in embodiments of the invention. Light scattering or reflective materials that may be utilized in embodiments of the invention are listed in “The Printing Ink Manual”, ed. Leach R. H. & Pierce R. J., Kluwer Academic Publishers, Dordrecht, Netherlands, 5^{th} edition, 1993, Chapter 4, pp 142-196, which is incorporated by reference herein in its entirety as if fully set forth.

TABLE 2

| | Excitation | Emission |
|---|---|---|
| Material | Wavelength (nm) | Wavelength (nm) |
| Lucifer yellow | 425 | 528 |
| NBD | 466 | 539 |
| R-Phycoerythrin (PE) | 480; 565 | 578 |
| PE-Cy5 conjugates | 480; 565; 650 | 670 |
| Red 613 | 480; 565 | 613 |
| Fluorescein | 495 | 519 |
| FluorX | 494 | 520 |
| BODIPY-FL | 503 | 512 |
| TRITC | 547 | 572 |
| X-Rhodamine | 570 | 576 |
| Lissamine Rhodamine B | 570 | 590 |
| PerCP | 490 | 675 |
| Texas Red | 589 | 615 |
| Allophycocyanin (APC) | 650 | 660 |
| TruRed | 490, 675 | 695 |
| Alexa Fluor | 430 | 545 |
| Alexa Fluor | 494 | 517 |
| Alexa Fluor 532 | 530 | 555 |
| Alexa Fluor 546 | 556 | 573 |
| Alexa Fluor 555 | 556 | 573 |
| Alexa Fluor 568 | 578 | 603 |
| Alexa Fluor 594 | 590 | 617 |
| Alexa Fluor 633 | 621 | 639 |
| Alexa Fluor 647 | 650 | 668 |
| Alexa Fluor 660 | 663 | 690 |
| Alexa Fluor 680 | 679 | 702 |
| Alexa Fluor 700 | 696 | 719 |
| Alexa Fluor 750 | 752 | 779 |
| Cy2 | 489 | 506 |
| Cy2 | (512); 550 | 570; (615) |
| Cy3.5 | 581 | 596; (640) |
| Cy5 | (625); 650 | 670 |
| Cy5.5 | 675 | 694 |
| Cy7 | 743 | 767 |
| Chromomycin A3 | 445 | 575 |
| Mithramycin | 445 | 575 |
| YOYO-1 | 491 | 509 |
| SYTOX Green | 504 | 523 |
| SYTOX Orange | 547 | 570 |
| Ethidium Bromide | 493 | 620 |
| 7-AAD | 546 | 647 |
| Acridine Orange | 503 | 530/640 |
| TOTO-1, TO-PRO-1 | 509 | 533 |
| Thiazole Orange | 510 | 530 |
| Propidium Iodide (PI) | 536 | 617 |
| TOTO-3, TO-PRO-3 | 642 | 661 |
| LDS 751 | 543; 590 | 712; 607 |
| Fluo-3 | 506 | 526 |
| DCFH | 505 | 535 |
| DHR | 505 | 534 |
| Y66F | 360 | 508 |
| Wild Type | 396, 475 | 508 |
| GFPuv | 385 | 508 |
| S65A | 471 | 504 |
| S65C | 479 | 507 |
| S65L | 484 | 510 |
| S65T | 488 | 511 |
| EGFP | 489 | 508 |
| ZsGreen1 | 493 | 505 |
| EYFP | 514 | 527 |
| ZsYellow1 | 527 | 539 |
| DsRed, DsRed2 (RFP) | 558 | 583 |
| DsRed monomer | 556 | 586 |
| AsRed2 | 576 | 592 |
| mRFP1 | 584 | 607 |
| HcRed1 | 588 | 618 |
| Calcein | 496 | 517 |

TABLE 3

| Material | Type of Phosphor | Persistence |
|---|---|---|
| ZnS:Ag + (Zn,Cd)S:Ag(P4) | white | |
| Y₂O₂S:Eu + Fe₂O₃ (P22R) | red | |
| ZnS:Cu,Al (P22G) | green | |
| ZnS:Ag + Co-on-Al₂O₃ (P22B) | blue | |
| Zn₂SiO₄:Mn (P1, GJ) | yellowish- | 1-100 ms |
| | green(525 nm) | persistence |
| ZnS:Ag,CI or ZnS:Zn (P11, BE) | blue (460 nm) | 0.01-1 ms |
| | | persistence |
| (KF,MgF₂):Mn (P19, LF) | yellow (590 nm) | |
| (KF,MgF₂):Mn (P26, LC) | orange (595 nm) | over |
| | | 1 second |
| | | persistence |
| (Zn,Cd)S:Ag or (Zn,Cd)S:Cu | yellow-green | 1-100 ms |
| (P20, KA) | | persistence |
| ZnO:Zn (P24, GE) | green (505 nm) | 1-10 us |
| | | persistence |
| (Zn,Cd)S:Cu,C1 (P28, KE) | yellow | |
| ZnS:Cu or ZnS:Cu,Ag (P31, GH) | yellowish-green | 0.01-1 ms |
| | | persistence |
| MgF₂:Mn (P33, LD) | orange (590 nm) | over |
| | | 1 second |
| | | persistence |
| (Zn,Mg)F₂:Mn (P38, LK) | orange (590 nm) | |
| Zn₂SiO₄:Mn,As (P39, GR) | green (525 nm) | |
| ZnS:Ag + (Zn,Cd)S:Cu (P40, GA) | white | |
| Gd₂O₂S:Tb (P43, GY) | yellow-green (545) | |
| Y₂O₂S:Tb (P45, WB) | white (545 nm) | |
| Y₂O₂S:Tb | green (545 nm) | |
| Y₃Al₅O₁₂:Ce (P46, KG) | green (530 nm) | |
| Y₃(A1,Ga)₅O₁₂:Ce | green (520 nm) | |
| Y₂SiO₅A:Ce (P47, BH) | blue (400 nm) | |
| Y₃A15O₁₂:Tb (P53, KJ) | yellow-green (544 nm) | |
| Y₃(A1,Ga)₅O₁₂:Tb | yellow-green (544 nm) | |
| ZnS:Ag,A1 (P55, BM) | blue (450 nm) | |
| InBO₃:Tb | yellow-green (550 nm) | |
| InBO₃:Eu | yellow (588 nm) | |
| ZnS:Ag | blue (450 nm) | |
| ZnS:Cu,A1 or ZnS:Cu,Au,A1 | green (530 nm) | |
| Y₂SiO₅:Tb | green (545 nm) | |
| (Zn,Cd)S:Cu,C1 + | white | |
| (Zn,Cd)S:Ag,C1 | | |
| InBO₃:Tb + InBO₃:Eu | amber | |
| ZnS:Ag + ZnS:Cu + Y₂O₂S:Eu | white | |
| InBO₃:Tb + InBO₃:Eu + ZnS:Ag | white | |

In some embodiments the particles include one scattering or emissive substance, while in others the particles include combinations of scattering and emissive substance. The combinations may include different types of scattering material, combinations of scattering and emissive material, or different types of emissive material. In a preferred embodiment, particles for a non-patterned enhanced reflective layer include a combination of TiO₂ particles and/or fluorescent or phosphorescent particles. Further preferred particles are reflective metals and alloys such as silver or aluminum. For patterned reflector layers, the preferred particles also include the particles listed in Table 1.

In embodiments where an emissive substance is included in the medium or particles of an enhanced reflective layer or any additional layer, the emissive substance may capture light at shorter wavelengths and emit longer wavelength light. By utilizing the properties of emissive substances in this fashion, a reflective display can be provided that is brighter. For example, an emissive substance may capture ultra-violet light, emit visible light, and thereby brighten the display.

In still other embodiments, the emissive substances included in particles are chosen to be complementary to the colored scattering or reflective particles, a color filter, or to the color of a frequency selective electro-optic layer. In preferred embodiments, non-ideal responses of the particles, color filter, or electro-optic material may be improved by inclusion of an emissive substance(s). In still preferred embodiments, the emissive substance so included absorbs non-desired wavelengths and emits light in the desired color spectrum. Such a system may be used to improve color saturation and gamut.

In still other embodiments, the enhanced reflective layer may be divided into areas such that particles with different optical properties are separated, and control of the electro-optic material over individual areas allows selective display of the different optical particles. For example, different colored particles, emissive particles, or combinations thereof may be separated into different areas.

In some embodiments, the enhanced reflective layer may be overcoated with a thin additional layer of a material. Like the medium of the enhanced reflective layer, the additional layer medium may also be translucent, substantially transparent, or transparent. In preferred embodiments the additional layer is comprised of medium that is similar to the enhanced reflective layer, but without any particles. The additional layer may be provided to ensure isolation of the particles from the subsequent layers of a reflective display. The isolation may include insulation from electrical, chemical, or physical environments of a reflective display that would be detrimental to the particles. For example, a non-neutral electrolyte material may be chemically reactive with a substance included in a reflective particle and the additional layer would insulate the particle from the electrolyte. In a preferred embodiment, the refractive index of the overcoating additional layer is within 50% of the refractive index of the previous deposition layer; in more preferred embodiments, the refractive index is within 35%, and in still more preferred embodiment, the refractive index of the two layers is closely matched, for example within 20%. Yet even more preferably, the overcoating layer is the same material used in the medium of the previous deposition. In yet further embodiments, more than one additional layer is provided.

In some embodiments, either the enhanced reflective layer and/or the additional layer insulate components of reflective display from each other. For example, the electrical components of an electrochromic display may be insulated from the electrolyte with one or both of these layers.

In some embodiments, suitable materials for the medium of the enhanced reflective layer or the additional layer include, but are not limited to polyimides, polyurethanes, epoxies, polyacrylates and spin-on-glasses.

As described below, the particles may be suspended, segment, or peripheral particles. Depending on the application, suspended, peripheral, or segment particles may include the same or different compositions and/or optical properties.

In further embodiments, the suspended, segment particles are applied in an ink and the solid loading of suspended, segment, or peripheral particles is preferably between 3-30% of the volume of the ink, and more preferably between 3-15% for the reflective particles including, but not limited to those listed in Table 1. In some embodiments including emissive particles, the preferable solid loading of the emissive particles is less than 10%, and still more preferably less than 2%.

In preferred embodiments that include reflective particles, the preferred particle size is less than or equal to one half the wavelength of the desired reflectance peak. For white particles in these embodiments, the particle size is preferably between 0.2 and 0.3 μm.

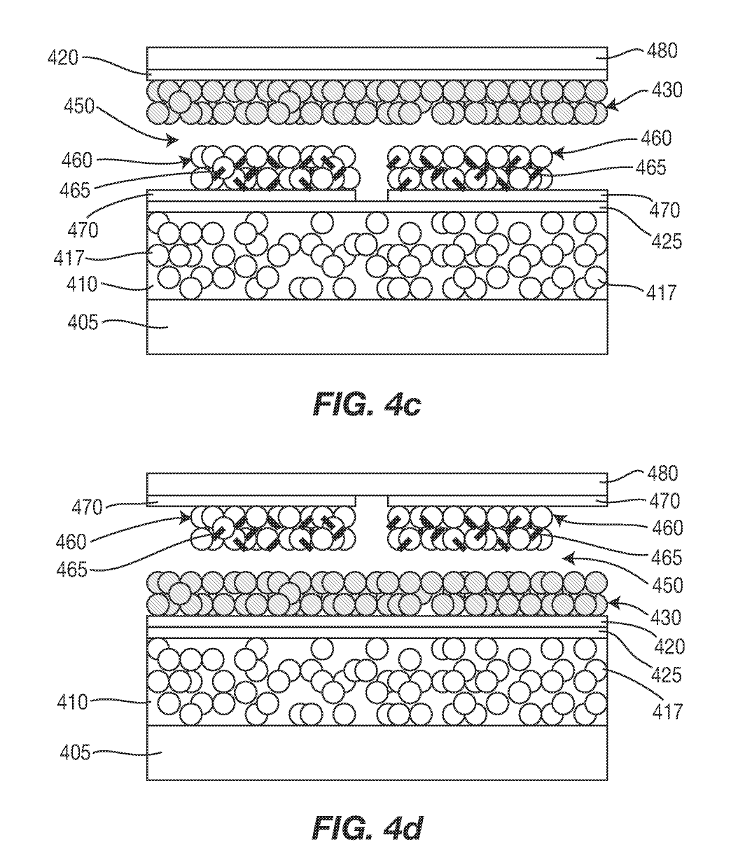

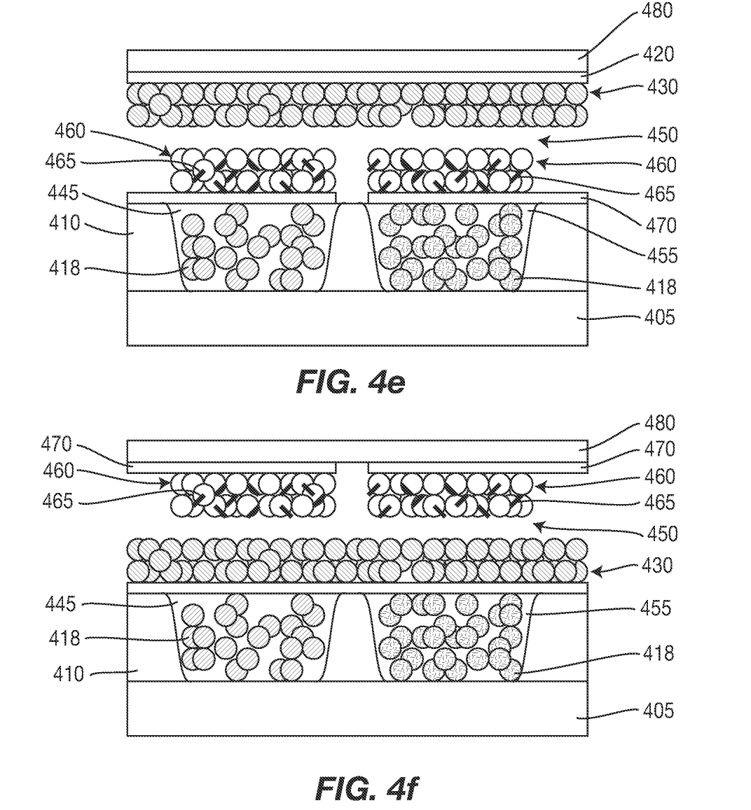

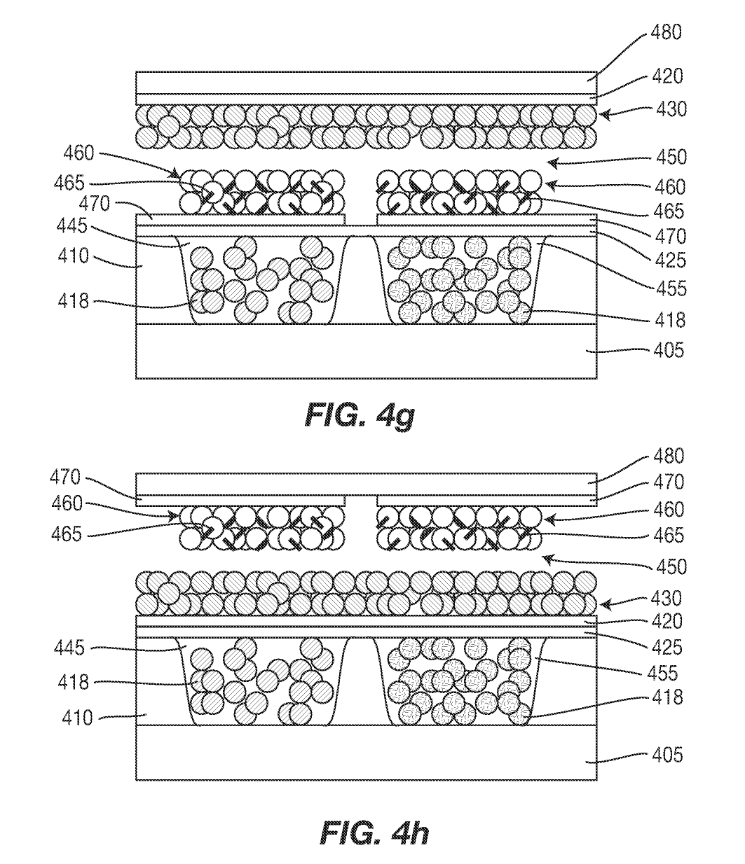

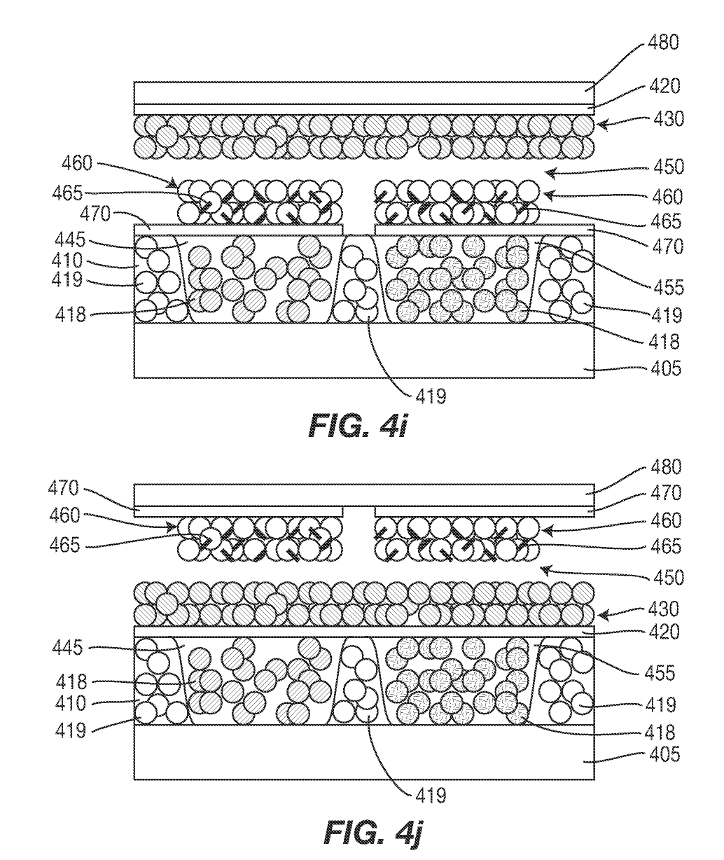

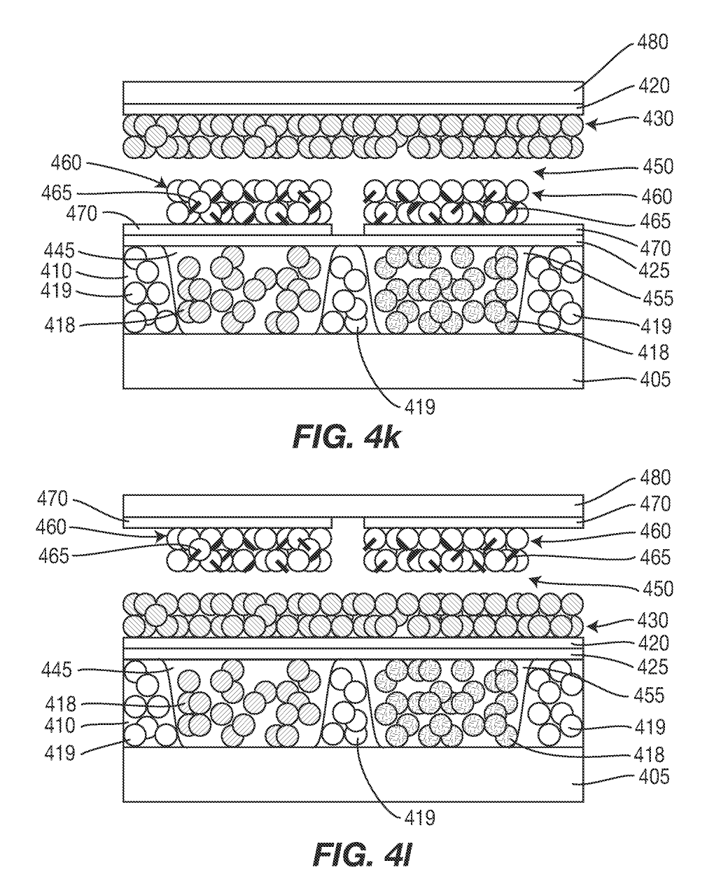

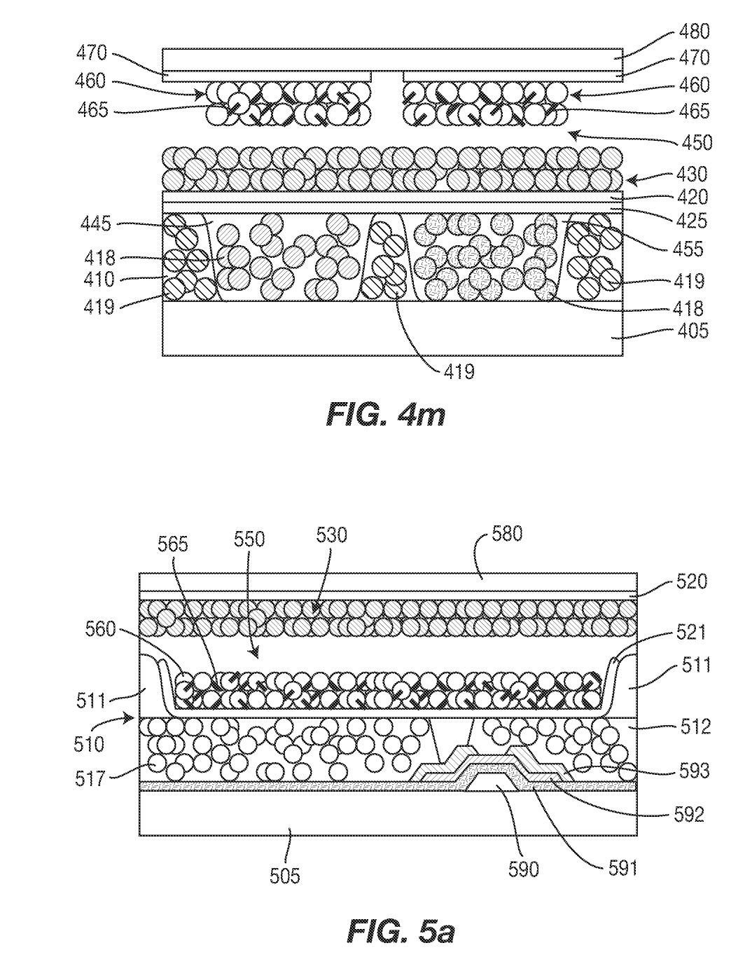

Referring to FIG. 4a, an embodiment of the present invention is illustrated where an enhanced reflective layer 410 is included in an electrochromic device 401. The electrochromic device 401 has substrates 405 and 480 on the bottom and top of the device, respectively.

A transparent conductive layer 420 is beneath substrate 480, and a substantially transparent nano-structured metal-oxide semiconductor layer 430 is, in turn, beneath the transparent conductive layer 420. In a preferred embodiment, transparent conductive layer 420 is indium doped tin oxide (ITO), nano-structured metal-oxide semiconductor layer 430 is either antimony doped tin oxide (ATO) or fluorine doped tin oxide (FTO), and substrate 480 is glass, plastic or other transparent material.

An enhanced reflective layer 410 is on top of a substrate layer 405. The substrate 405 may comprise materials such as glass, plastic, fabrics of various compositions, metal, and the like. Accordingly, these materials may be rigid or flexible. With respect to the enhanced reflective layer 410 and the substrate 480, a patterned layer of transparent conductive material 470 is proximal to, and on top of the reflective layer 410. A patterned layer of nano-structured metal-oxide semiconductor 460 with adsorbed chromophore 465 is, in turn, on the transparent conductive material 470. The patterned conductive material 470 and patterned semiconductor define controllable areas for the color changing materials. In a preferred embodiment, the patterned conductive material 470 is ITO, and the patterned layer of nano-structured metal-oxide 460 with adsorbed chromophore 465 includes titanium oxide and a viologen.

An electrolyte 450 is included between the conductive layers 420, 470. Spacers (not shown) may be provided between the top and bottom substrates 405, 480 to prevent layers 430 and 460 from touching. The assembled electrochromic device thus has an electrode comprised of conductive layers 420, 470 connected through electrolyte 450. In addition, the electro-optic chromophore 465 is operatively connected with the electrode because application of charge through the electrode will induce the redox reactions required to modulate the chromophore 465. Through the modulation of chromophore 465, the reflective layer 410 may be selectively exposed to incident light.

The enhanced reflective layer 410 includes suspended particles 417 of a desired optical nature. Incident light from above is transmitted through the top substrate 480 and through the semiconductor layer 430. When patterned layer 460, 470 is not charged to a substantially opaque or opaque state via the redox state of the chromophore 465, the light passes through patterned layer 460, 470 and strikes the reflective layer 410. At least a portion of the light is then re-directed toward the viewer.

In an embodiment, the suspended particles are in a colloidal dispersion in a liquid medium. After mixing, the liquid medium is fixed and because the particles are in a colloidal dispersion, there is no substantial settling of the particles during fixing. In these embodiments, fixing of the medium can include removing the solvent. Removing the solvent can be done be a number of methods, and in preferred embodiments is accomplished through baking. As detailed below, segment particles and peripheral particles may also be utilized.

Suspended particles 417 may be uniformly or non-uniformly dispersed. In preferred embodiments, the suspended particles 417 are nominally uniformly dispersed. In addition, suspended particles 417 may all comprise the same kind of particle, or be different with respect to the size and/or composition. In an embodiment, many different kinds of suspended particles 417 are dispersed within the medium of the enhanced reflective layer 410. The different kinds of suspended particles 417 may include reflective and emissive particles. In another embodiment, a suspended particle 417 may include multiple functional properties. For example, a single suspended particle 417 may include constituents that impart reflectivity and emissive properties to the suspended particle 417. Preferred compositions of suspended particles include substances selected from those listed in Table 1. In embodiments where a white state of the reflective layer is desired, the size and density of suspended particles 417 is designed to scatter the incident visible light back towards the observer. In a preferred embodiment, particles 417 include TiO₂ of between 0.2-0.3 μm in diameter and at a solid loading of between 3-30% of the ink.

Within the medium of reflective layer 410, the suspended particles 417 may be mechanically and/or chemically insulated from corrosive environments. Because the suspended particles 417 are mechanically and/or chemically insulated, it is possible to provide additional suspended particles with varying properties. The additional suspended particles 417 may be comprised solely of substances imparting the varying properties, or the suspended particles 417 may be composites of material. In a preferred embodiment, the suspended particles 417 include emissive substances in order to increase the brightness of the reflector layer, and in turn, the emissive substances include fluorescent and/or phosphorescent moieties. Emissive substances that may be used in preferred embodiments of the invention are listed in TABLES 2 and 3.

A particularly preferred emissive substance is Ciba Specialty Chemicals Uvitex® OB or 4,4′-bis(benzoxazol-2-yl) stilbene at a density of between 0.005 to 1% within reflective layer 410. The inclusion of emissive substances provides a more pleasing viewer experience and also allows for tuning of the color response of the system.

FIGS. 4b-d illustrate various embodiments of the invention within an electrochromic display environment. FIG. 4b illustrates that segmented and common electrode layers may be swapped depending on the application requirements. In the particular embodiment depicted in FIG. 4b, layers 420, 430 are swapped with layers 460, 470. As illustrated, the transparent conductive layer 420 is on top of reflective layer 410 and nano-structured metal-oxide semiconductor layer 430 is on top of the transparent conductive material 420. Also, the layer of transparent conductive material 470 is next to substrate 480 with the patterned layer of nano-structured metal-oxide semiconductor 460 with adsorbed chromophore 465 beneath the layer 470. In this arrangement, electro-optic material (i.e., adsorbed chromophore 465) and a patterned transparent conductive layer 170 may be referred to as distal to the enhanced reflective layer 410.

FIG. 4c illustrates that further layers of insulating material may be utilized to protect the reflective layer 410 or underlying electronics. As depicted in FIG. 4c, an additional transparent layer 425 is provided which can further insulate the suspended particles 417 from adverse environments, e.g. an electrolyte. Preferably, the additional transparent layer 425 is a thin layer of the same medium used in layer 410 but without the addition of particles. Both of these layers could be deposited by printing or coating without the need for intermediate steps, and thus the process is not significantly more complex or costly by inclusion of additional transparent layer 425.

In alternative embodiments, the material of enhanced reflective layer 410 and additional transparent layer 425 are different. In some embodiments, the additional transparent layer 425 is comprised of insulative material, while the material of enhanced reflective layer 410 is adapted to accommodate the nature of suspended particles 417. For example, suspended particles 417 may require a medium that is not insulative in order properly disperse in the medium. In these embodiments, additional layer 425 would provide insulative properties in place of the insulative properties of reflective layer 410.

In other embodiments, additional transparent layer 425 may be applied to “planarize” or smooth the exterior layer of a reflective display device as it is assembled. In these embodiments, deposition of subsequent layers is facilitated because the transparent layer 425 would provide a planar surface. The medium of the reflective layer 410 may be referred to as a first medium and the medium the additional layer 425 as a second medium.

FIG. 4d illustrates that the embodiments contemplated in FIGS. 4b and 4c may be combined. In the particular embodiment depicted, the segmented and common electrode layers are swapped, and an additional transparent layer 425 is added.

FIGS. 4e-h depict further embodiments of the invention based on the embodiments contemplated in FIGS. 4a-d, respectively. In each FIG. 4e-4h, additional segmented areas 445 and 455 of the reflective layer 410 are illustrated. Within segmented areas 445, 455 there are segment particles 418. Segment particles 418 may be the same as or different in quantity, quality and composition as suspended particles 417. As illustrated, it is possible to provide segment particles 418 of a different nature in segment area 445 versus segment area 455. In preferred embodiments, mutually different combinations of colored reflective particles and fluorescent particles may be deposited in different segmented display areas 445 and 455 in order to selectively color reflected light. In this way, a colored display may be created which is capable of enhanced polychromatic color. In some embodiments, an additional transparent layer may be applied within segment areas 445, 455 to insulate segment particles 418.

In some embodiments both colored and emissive particles may be included in a given segmented display area 445 or 455. The color or emissive properties may be combined in one segment particle 418 or different segment particles 418 within a single segmented area 445 or 455. In addition, the color of the reflective and/or fluorescent particles may be matched to the absorption characteristics of the chromophore(s) in the on or off state, or to each other, in order to optimize the reflected light from that segment area for a desired color response. One of skill in the art will recognize that any number of segment areas could be provided to affect selective filtering. In embodiments, the number of segmented areas is adapted to suit the particular application. For example, a full color display may require red, green and blue reflective areas which may be accommodated in three different segmented areas.

In the embodiments provided in FIGS. 4e-4h, the reflective layer 410 may be made of a patterned layer with segmented layers 445, 455. The segmented areas, 445 and 455, may be deposited into spaces in the patterned layer 430. In a preferred embodiment, the components of segmented areas 445, 455 and particles 418 are deposited by printing, which enables a substantially planar surface for subsequent depositions (i.e., planarization).

FIGS. 4g-4h illustrate the inclusion of an additional transparent layer 425. Additional layer 425 may be deposited on to the reflector layers to isolate any reactive particles from the electrolyte and additionally to provide further planarization of the combined layer.

FIGS. 4i-l depict further embodiments of the invention based on the embodiments of FIGS. 4g-h, respectively. In each of FIGS. 4i-l, the reflective layer 410 is illustrated as a patterned layer having segmented areas 445, 455 and peripheral particles 419. Peripheral particles 419 may be the same or different than either suspended particles 417 or segment particles 418. In some embodiments, areas peripheral to the segmented areas 445, 455 may incorporate peripheral particles 419 with a particular optical property which may differ from the optical properties in the adjacent segmented areas 445, 450. In these embodiments, brightness enhancement, such as by emissive particles, may be added by inclusion of peripheral particles 419. In addition, the reflectivity of the display and the contrast of the colored segments with respect to a background may be enhanced with peripheral particles 419.

Referring to FIG. 4m, particles 417, 418, and/or 419 may absorb, rather than reflect or emit, incident light. FIG. 4m depicts an embodiment where the peripheral particles 419 absorb in order to provide contrast with the colored segment areas 445, 450.

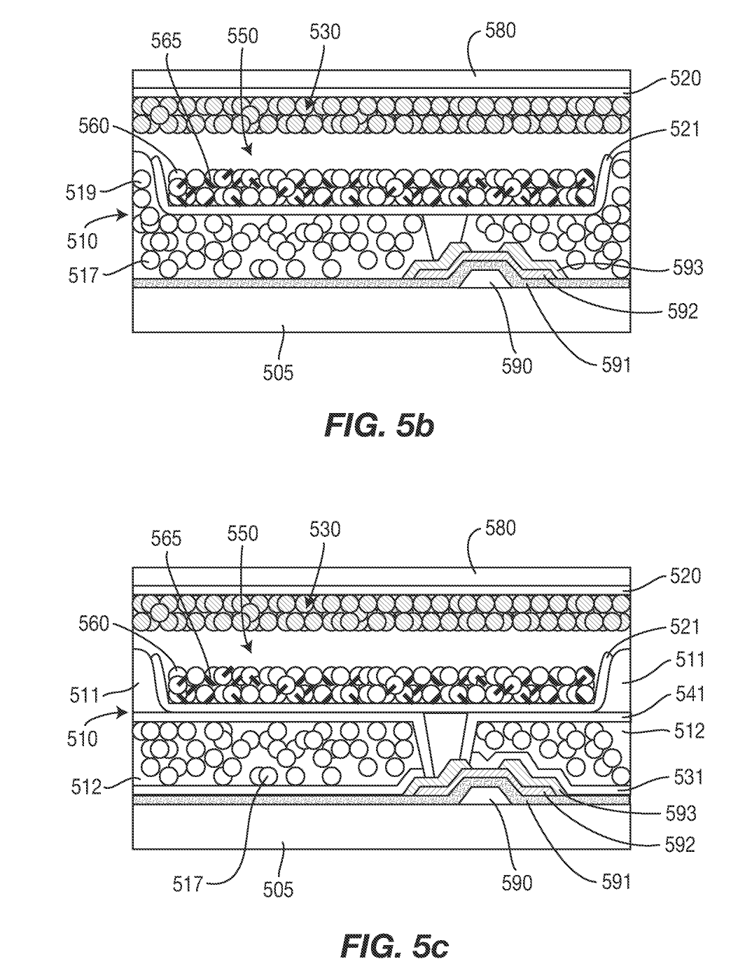

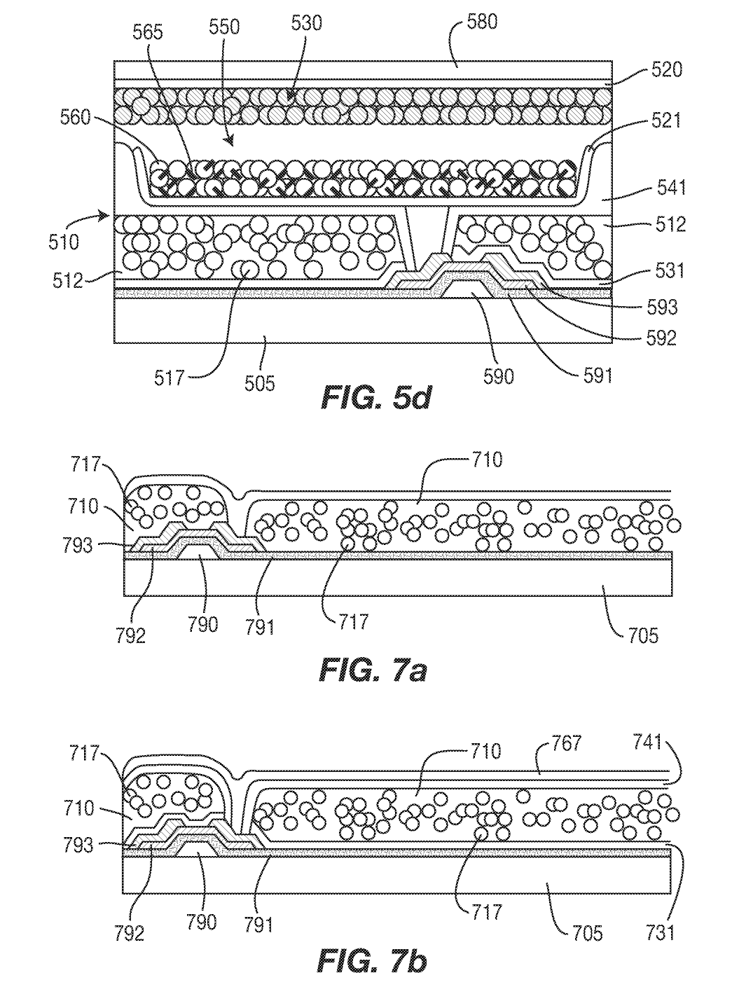

FIGS. 5a-d illustrate embodiments of the present invention in the environment of an active matrix electrochromic display. In FIGS. 5a-d, an active matrix electrochromic display similar to that disclosed in U.S. application Ser. No. 11/536,316 (which is incorporated by reference herein in its entirety as if fully set forth) is modified to include additional particles in an enhanced reflective layer 510. One of ordinary skill in the art will readily appreciate that the electro-optic chromophore 565 is operatively connected to a thin film transistor (TFT) 590-593 in order to selectively expose the underlying enhanced reflective layer 510. In embodiments illustrated in several of the figures, a TFT control element is designated by X90-X93 where X is the figure number. For example, 590-593 designates a TFT in embodiments illustrated in FIGS. 5a-5d.

In preferred embodiments, the suspended particles 517 include fluorescent or phosphorescent substances, including polymers in some alternatives, as defined in TABLES 1-3.

Referring to FIGS. 5a and 5b, embodiments of the invention are illustrated where reflective layer 510 includes different combinations of tiers or sub-layers. In one embodiment, as illustrated in FIG. 5a, reflective layer 510 is made of two layers, 511 and 512. Layer 510 may contain a neutral medium designed to transmit light, or it may also contain peripheral particles (not shown). In another embodiment, illustrated in FIG. 5b, the reflective layer 510 includes one layer. The use of one and two layers may facilitate deposition of materials according to the reflector functionality desired. For example, the reflector functionality may be deposited in the first layer 512 incorporating suspended particles 517. The wells 521 designed to contain electro-optic material may then be deposited on top of the first layer 512 as second layer 511. Alternatively, if the same particle is designed to be both a suspended particle 517 and a peripheral particle, then one layer may be deposited in one application. It may be preferable to deposit the layers in one or other of these methods depending on the deposition and/or etching method used.

In some embodiments, reflective layer 510 may contain conductive particles, or particles that may otherwise react with adjacent layers. FIG. 5c illustrates the use of optional layers, 531 and 541, either or both of which may be added. In one embodiment, one or both optional layers 530, 540 are made of the same medium material that comprises layer 510, but without suspended, peripheral or segment particles. In these embodiments, optional layers 531, 541 provide a protective layer between layer 510 and TFT 590-593 layers, or layer 510 and the electro-optic layers. The medium of optional layer 541 may be referred to as a second medium (like the additional layer 425, see, for example, FIG. 4g), and the medium 531 may be referred to as a third medium.

Referring to FIG. 5d, an alternative embodiment is illustrated for the arrangement of optional layer 541. In this embodiment, optional layer 541 provides the structure of second layer 511 (see FIG. 5a).

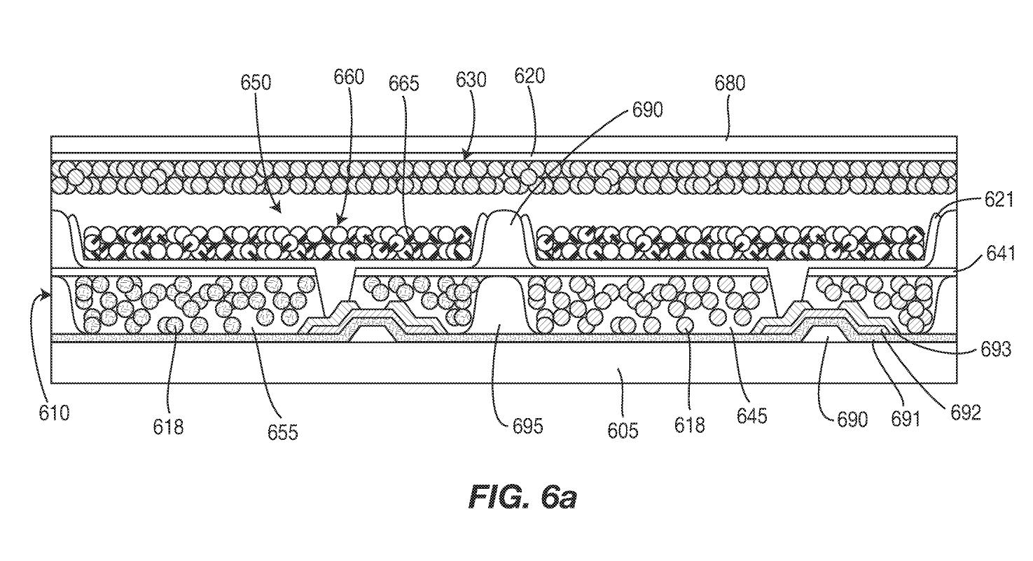

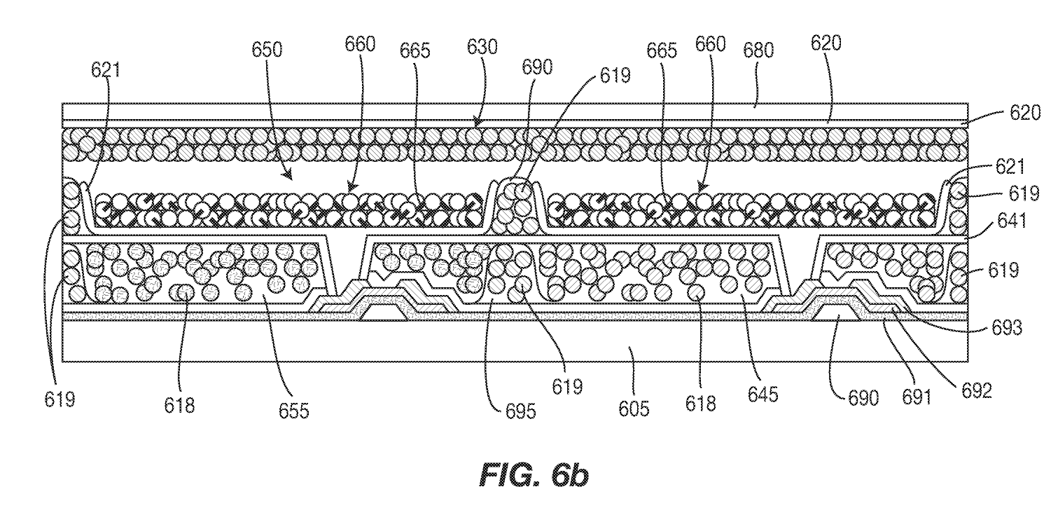

FIGS. 6a and 6b depict embodiments of the invention in another active-matrix electrochromic display environment. As illustrated in FIG. 6a, embodiments of the present invention include adjacent segments 645, 655 that may incorporate differently colored particles and/or a combination of emissive particles with varying excitation and emission characteristics. As shown in FIG. 6b, a further embodiment includes peripheral particles 619 in intermediate areas 690 and/or 695 so as to present a particular optical response in the intermediate areas. In a preferred embodiment, intermediate areas 690 and/or 695 absorb light and serve the equivalent of a black mask (a black mask is often used in displays to prevent various image distortions or color crosstalk issues). Absorption of light may be provided by peripheral particles 619.

FIGS. 7a illustrates embodiments of the current invention in a reflective LC display. In one embodiment, the enhanced reflective layer 710 is insulative and not patterned between pixels, in contrast to metallic reflective layers. Because enhanced reflective layer 710 is insulative, a patterned pixel electrode 791 may be directly applied to the reflective layer 710. In this case, the brightness of the enhance reflector layer 710 may be enhanced by the addition of fluorescent/phosphorescent particles in the enhanced reflector layer 710.

FIG. 7b illustrates embodiments of the current invention in a reflective LC display that include optional separation layers 731, 741. As with previous embodiments, suspended particles 717 may be included in enhanced reflective layer 710.

One of ordinary skill in the art will readily appreciate that the electro-optic liquid crystal is operable connected to the TFT such that the underlying enhanced reflective layer 710 can be selectively exposed to incident light.

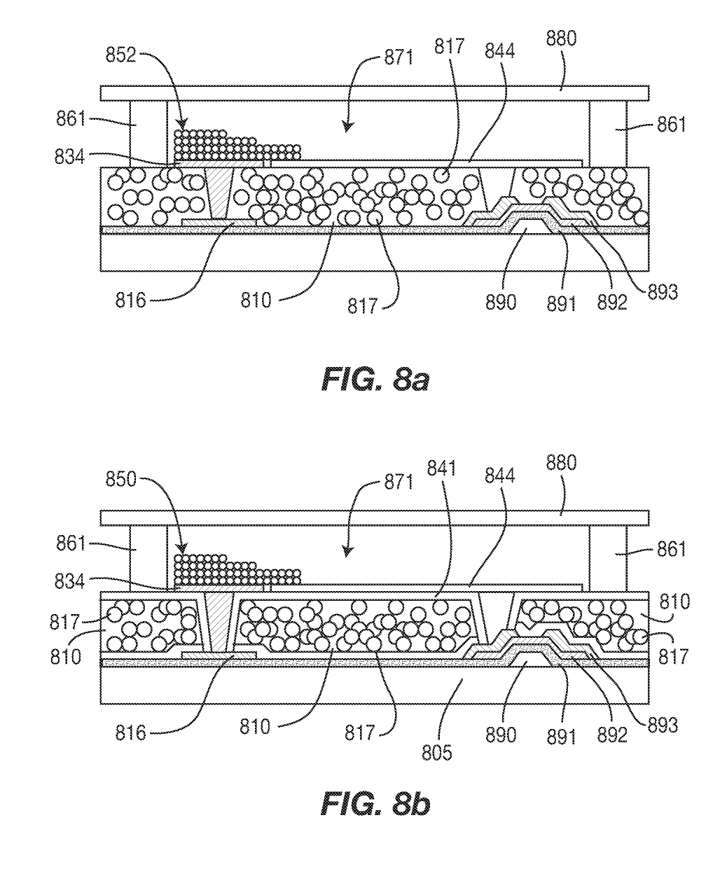

FIGS. 8a and 8b illustrate embodiments of the current invention in an active-matrix addressed lateral electrophoretic device. Referring to FIG. 8a, the opaque reflective layer normally found in an electrophoretic device is replaced with an enhanced reflective layer 810. In this case, the reflector layer may be enhanced through suspended particles 817. In preferred embodiments, the suspended particles 817 include fluorescent/phosphorescent particles which increase the brightness of the visible radiation. Additionally, the reflector material may be patterned to provide adjacent areas of colored reflector. FIG. 8b illustrates that embodiments of the current invention in the electrophoretic display environment may also include one or both of additional transparent layers 831, 841. As with other displays, one of ordinary sill in the art will readily appreciate that the charged electrophoretic particles 852 are operatively connected to the TFT such that the underlying enhanced reflective layer 810 is selectively exposed to incident light.

Additional LC, and electrophoretic embodiments may be extrapolated from the embodiments described in the electrochromic environment; including variations reflective layer structure and composition. The variations include, but are not limited to variations in surrounding areas (e.g., different layers, suspended particles, segment particles, peripheral particles, intermediate areas, tiers of a reflective layer, etc.) and variations in the composition of reflective material (e.g., substance(s) imparting a particular color or emissive property in suspended, segment or peripheral particles). Also, other display effects not listed, such as electrowetting, dielectrophoretic, liquid powder or other LC effects, etc. may make use of an enhanced reflector layer as described in the embodiments disclosed herein.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A display comprising:
(a) an electro-optic material operatively connected to a control element;
(b) a reflective layer located beneath the electro-optic material including first medium and particles;
the electro-optic material being switchable from a first state in which incident light may strike the enhanced reflective layer and a second state in which incident light is at least partially blocked from the reflective layer, and the state of the electro-optic material is controlled through the control element.

2. The display of claim 1, the particles comprise suspended particles including at least one substance selected from the group consisting of light scattering or reflective particles, and emissive substances.

3. The display of claim 2, the light scattering or reflective particles selected from the group consisting of titanium dioxide, zinc oxide, zirconium oxide, cadmium sulfide, cadmium selenide, sodium aluminosilicate, chromium (III) oxide, and carbon black.

4. The display of claim 2, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).

5. The display of claim 1, the reflective layer comprising a patterned layer including segmented areas and the particles in the segment areas comprise segment particles.

6. The display of claim 5, the segment particles including at least one substance selected from the group consisting of light scattering or reflective particles, and emissive substances.

7. The display of claim 6, the light scattering or reflective particles selected from the group consisting of titanium dioxide, zinc oxide, zirconium oxide, cadmium sulfide, cadmium selenide, sodium aluminosilicate, chromium (III) oxide, and carbon black.

8. The display of claim 6, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).

9. The display of claim 5, the particles further comprising peripheral particles located in areas other than the segmented areas.

10. The display of claim 9, the peripheral particles including at least one substance selected from the group consisting of light scattering or reflective particles, and emissive substances.

11. The display of claim 10, the light scattering or reflective particles selected from the group consisting of titanium dioxide, zinc oxide, zirconium oxide, cadmium sulfide, cadmium selenide, sodium aluminosilicate, chromium (III) oxide, and carbon black.

12. The display of claim 10, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).

13. The display of claim 5, further comprising intermediate areas between the segmented areas.

14. The display of claim 13, the intermediate areas further comprising peripheral particles.

15. The display of claim 14, the peripheral particles including at least one substance selected from the group consisting of light scattering or reflective particles, and emissive substances.

16. The display of claim 15, the light scattering or reflective particles selected from the group consisting of titanium dioxide, zinc oxide, zirconium oxide, cadmium sulfide, cadmium selenide, sodium aluminosilicate, chromium (III) oxide, and carbon black.

17. The display of claim 15, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).

18. The display of claim 1, the reflective layer comprising a patterned layer including segmented areas and the particles further comprise peripheral particles located in areas other than the segmented areas.

19. The display of claim 18, the peripheral particles including at least one substance selected from the group consisting of light scattering or reflective particles, and emissive substances.

20. The display of claim 19, the light scattering or reflective particles selected from the group consisting of titanium dioxide, zinc oxide, zirconium oxide, cadmium sulfide, cadmium selenide, sodium aluminosilicate, chromium (III) oxide, and carbon black.

21. The display of claim 19, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).

22. The display of claim 1, the enhanced reflective layer comprising two tiers.

23. The display of claim 1, the first medium comprising a substance selected from the group consisting of polyimides, polyurethanes, epoxies polyacrylates and spin-on-glasses.

24. The display of claim 1, the display further comprising an additional transparent layer comprising a second medium on top of the enhanced reflective layer.

25. The display of claim 24, the second medium comprising a substance selected from the group consisting of polyimides, polyurethanes, epoxies polyacrylates and spin-on-glasses.

26. The display of claim 24, the second medium having a refractive index within 50% of the first medium.

27. The display of claim 26, the display further comprising another additional layer comprising a third medium and located beneath the enhanced reflective layer.

28. The display of claim 27, the third medium comprising a substance selected from the group consisting of polyimides, polyurethanes, epoxies polyacrylates and spin-on-glasses.

29. The display of claim 1, where the display is an electrochromic display and the electro-optic material comprises a chromophore.

30. The display of claim 1, where the display is a lateral electrophoretic display and the electro-optic material comprises charged electrophoretic particles.

31. The display of claim 1, where the display is a liquid crystal display and the electro-optic material comprises a liquid crystal.

32. A method of providing enhanced reflectivity in a display device, the display comprising (a) an electro-optic material operatively connected to a control element, (b) a reflective layer located on a substrate and beneath the electro-optic material, the reflective layer including first medium and particles; the electro-optic material being switchable from a first state in which incident light may strike the enhanced reflective layer and a second state in which incident light is at least partially blocked from the reflective layer, and the state of the electro-optic material is controlled through the control element; the method comprising:
applying the reflective layer to the substrate and the particles are selected from the group consisting of suspended particles, segment particles and peripheral particles.

33. The method of claim 32, the step of applying a reflective layer comprises applying the first medium with the particles by a method selected from the group consisting of printing, spin coating and laminating.

34. The method of claim 33, the method of printing selected from the group consisting of screen printing and ink-jet printing.

35. The method of claim 32, the step of applying selected from the group consisting of blade-coating, roll coating and spraying.

36. A method of enhancing the brightness in a display comprising providing an enhanced reflective layer including at least one type of particles selected from the group consisting of suspended particles, segment particles and peripheral particles.

37. The method of claim 36, at least one of the particles includes at least one substance selected from the group consisting of light scattering or reflective particles, and emissive substances.

38. The method of claim 37, the light scattering or reflective particles selected from the group consisting of titanium dioxide, zinc oxide, zirconium oxide, cadmium sulfide, cadmium selenide, sodium aluminosilicate, chromium (III) oxide, and carbon black.

39. The method of claim 37, the emissive substances selected from the group consisting of Lucifer yellow, NBD, R-Phycoerythrin, PE-Cy5 conjugates, 4,4′-bis(benzoxazol-2-yl) stilbene, ZnS:Ag+(Zn,Cd)S:Ag(P4), Y₂O₂S:Eu+Fe₂O₃ (P22R), ZnS:Ag+Co-on-Al₂O₃ (P22B), and ZnS:Cu,Al (P22G).
